(19) United States
(12) Patent Application Publication
(10) Pub. No.: US 2025/0116507 A1
(43) Pub. Date: Apr. 10, 2025

(54) FLAKE MEASUREMENT

(71) Applicant: Interstates, Inc., Sioux Center, IA (US)

(72) Inventors: Jaris Lance TILSTRA, Sioux Center, IA (US); Daniel Joseph RILEY, Sioux Center, IA (US); Bradley Gene VAN BERKEL, Sioux Center, IA (US); Dustin Michael SKLUZACEK, Sioux Center, IA (US); Tiati Leigh BAILEY, Sioux Center, IA (US); Nicholas Oliver MALOTT, Sioux Center, IA (US); Jackson Stephen CATES, Sioux Center, IA (US); Benjamin Matthew ARNOLD, Sioux Center, IA (US); Brock HEPPNER, Sioux Center, IA (US); Shane Anthony HEIER, Sioux Center, IA (US); Christopher Allen MAYO, Sioux Center, IA (US)

(73) Assignee: Interstates, Inc., Sioux Center, IA (US)

(21) Appl. No.: 18/912,305

(22) Filed: Oct. 10, 2024

Related U.S. Application Data
(60) Provisional application No. 63/543,385, filed on Oct. 10, 2023.

(51) Int. Cl. G01B 11/06; G06T 1/00; G06T 7/60

(52) U.S. Cl. CPC G01B 11/0608; G06T 1/0014; G06T 7/60; G06T 2207/30128

(57) ABSTRACT

A flake measurement system of an oilseed crush operation includes a sampling system to collect an oilseed flake from the oilseed crush operation and place the oilseed flake on a supporting surface, and an imaging system to determine a thickness of the oilseed flake, with the imaging system including an imaging device to capture an image of a surface of the oilseed flake, the imaging system to process the image to identify a local minima region of the surface of the oilseed flake, and the imaging system to determine the thickness of the oilseed flake based on displacement of the local minima region relative to the supporting surface.

### CROSS-REFERENCE TO RELATED APPLICATIONS

This application claims priority under 35 U.S.C. 119(e) to U.S. Provisional Patent Application Ser. No. 63/543,385 filed on Oct. 10, 2023, and incorporated herein by reference.

### BACKGROUND

The present disclosure relates generally to flake measurement and, more specifically, relates to a system and method to collect and measure a thickness of oilseed flakes of an oilseed crush operation.

### BRIEF DESCRIPTION OF THE DRAWINGS

FIG. 1 is a schematic illustration of an example of an oilseed crush operation system in accordance with the present disclosure.

FIG. 1a is a schematic illustration of an example of a portion of an oilseed crush operation system in accordance with the present disclosure.

FIG. 2 is a schematic illustration of an example of an oilseed crush operation system in accordance with the present disclosure.

FIG. 3 is a flow chart of an example of an oilseed crush operation method in accordance with the present disclosure.

FIG. 3a is a flow chart of an example of an oilseed crush operation method in accordance with the present disclosure.

FIG. 4 is a schematic illustration of an example of an imaging system of an oilseed crush operation system in accordance with the present disclosure.

FIG. 5 is an example of a 3D heightmap of a flake surface of an oilseed crush operation system in accordance with the present disclosure.

FIG. 6 is an example of data points representing a flake surface of an oilseed crush operation system in accordance with the present disclosure.

FIG. 7 is an example of an image of a flake surface of an oilseed crush operation system in accordance with the present disclosure.

FIG. 8 is a schematic illustration of an example of a measurement of flake thickness of an oilseed crush operation system in accordance with the present disclosure.

FIG. 9 is a schematic illustration of an example of a measurement of flake thickness of an oilseed crush operation system in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

The present disclosure provides for automating the process of collecting oilseed flakes from an oilseed crush operation and measuring and reporting flake thickness. In examples, based on flake thickness data captured in accordance with the present disclosure, flake rollers of the crush operation may be adjusted (for example, spacing between the flake rollers may be increased or decreased). In examples, based on flake thickness data captured in accordance with the present disclosure, adjustment of the flake rollers may be performed automatically through automated controls, or manually by an operator.

Automating the collection and measurement of oilseed flakes in accordance with the present disclosure may provide an opportunity to optimize oil yield from an oilseed crush operation by helping to maintain desired flake thickness. Automating the collection and measurement of oilseed flakes (or other flaked goods or flaked food products) in accordance with the present disclosure may facilitate more frequent sampling and more accurate measurement of flakes to guide adjustment of the flake rollers to obtain desired flake thickness. Automating the collection and measurement of oilseed flakes (or other flaked goods or flaked food products) in accordance with the present disclosure may reduce or eliminate operations staff time to manually collect and measure flakes. Automating the collection and measurement of oilseed flakes (or other flaked goods or flaked food products) in accordance with the present disclosure may provide the ability to analyze flake roller wear to optimize roller maintenance (for example, roller edge grinding) and/or roller replacement.

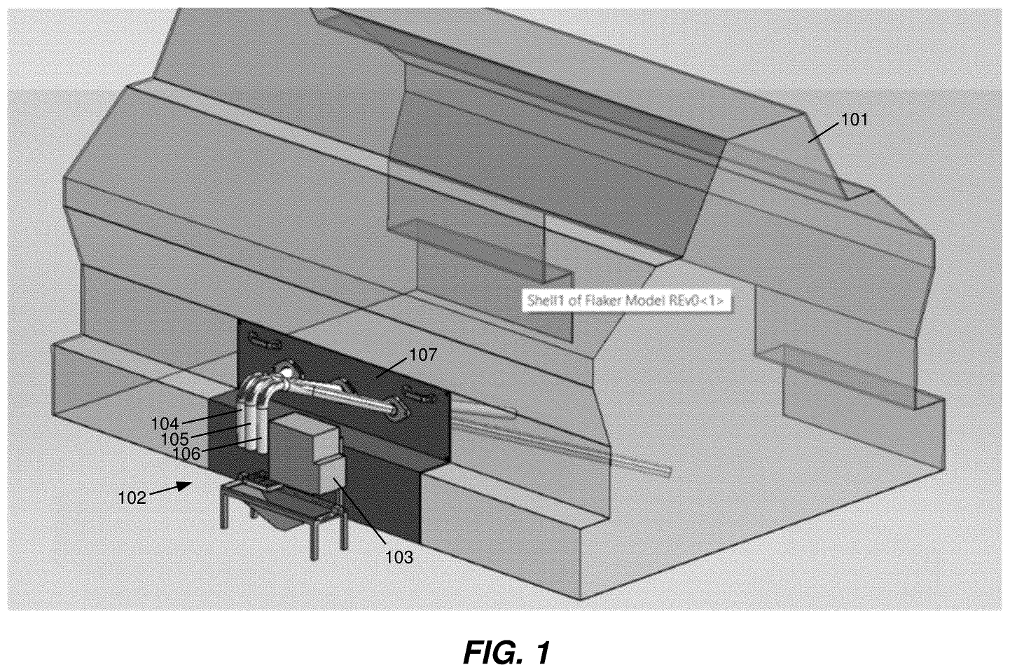

FIG. 1 is a schematic illustration of an example of an oilseed crush operation system in accordance with the present disclosure. In examples, an oilseed processing facility feeds oilseeds (for example, pre-processed oilseeds) into a crush process flaker unit (101). In examples, the flaker unit (101) crushes or flakes the oilseeds, flattening them to a pre-determined thickness for oil extraction in a later part of the production process. Example oilseeds that may be processed in accordance with the present disclosure include, for example, soybeans, cottonseeds, sunflower seeds, safflower seeds, rapeseeds, flaxseeds, sesame seeds, mustard seeds, canola seeds, castor beans, and peanuts.

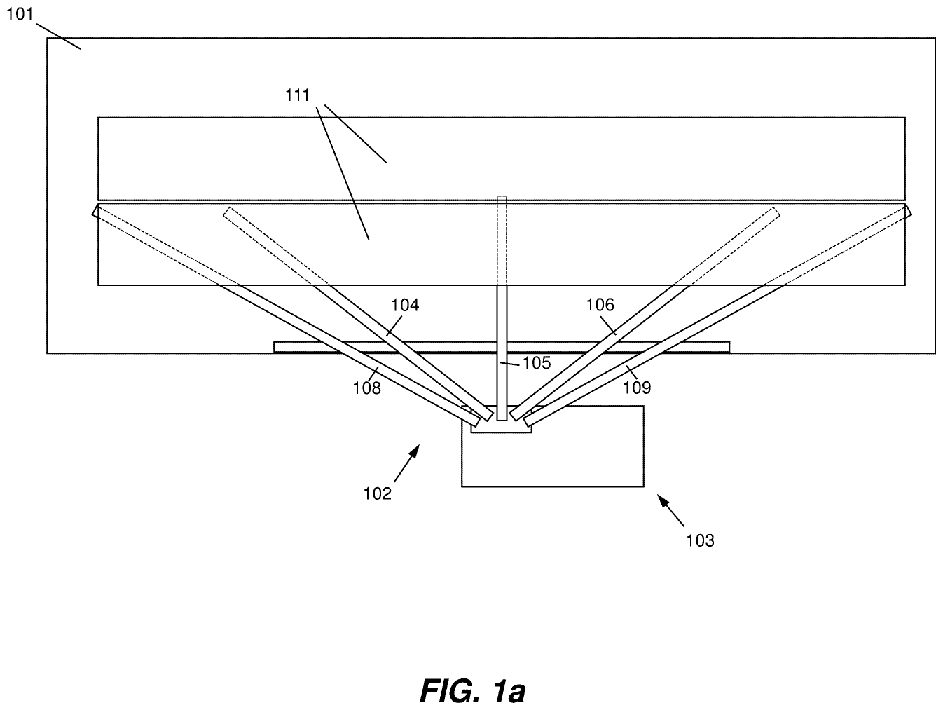

In examples, an oilseed crush operation system in accordance with the present disclosure includes a sampling system (102) for collecting samples of the flakes from the flaker unit (101) and an imaging system (103) for measuring and reporting flake thickness. In examples, the flaker unit (101) includes a hopper and opposing rollers which rotate to crush and produce flakes of oilseeds fed into the hopper and between the rollers. (See, for example, the hopper 112 and the rollers 111 of FIG. 2.)

In examples, components of the imaging system (103) are housed in an enclosure (such as, for example, a Hoffman NEMA 12 enclosure or a NEMA 4 enclosure) and include a camera or vision system (such as, for example, a Cognex In-Sight 3D camera or a Gocator 2330 3D profile scanner), as an example of an imaging device, for scanning or imaging the flake samples, a programmable logic controller (PLC) (such as, for example, a CompactLogix PLC), a power supply for providing power (for example, DC power) to the components, and a network switch for facilitating/establishing communication between the camera/vision system, PLC, and a control computer. (See, for example, the camera 6, the PLC 13, the power supply 14, the network switch 15, and the computer 7 of FIG. 2.)

In examples, the sampling system (102) includes a vacuum system with one or more collection tubes or pipes that extend into the flaker unit (101) under the crush rollers to collect samples of the flakes and an air/valve manifold for controlling the sampling system. In the illustrated example of FIG. 1, three collection or sampling tubes (for example, a left tube 104, a center tube 105, and a right tube 106) extend into the flaker unit (101) through an access panel (107) to extract samples of the flakes from different regions of the flaker unit (101). In other examples, the collection or sampling tubes extend into a transition between the flaker unit and a production conveyance system that moves crushed flakes to the next step in the production process. In examples, the vacuum system draws a vacuum using line vacuum conveyors operated from compressed air controlled with the PLC and the air/valve manifold.

FIG. 1a is a schematic illustration of an example of a portion of an oilseed crush operation system in accordance with the present disclosure. More specifically, FIG. 1a includes a schematic illustration of a top view of another example of the flaker unit (101). In the illustrated example of FIG. 1a, five collection or sampling tubes (for example, a left tube 104, a center tube 105, a right tube 106, a left edge tube 108, and a right edge tube 109) extend into the flaker unit (101) under the crush rollers (111) to extract samples of the flakes from different regions of the flaker unit (101).

In examples, sampled flakes are delivered to the imaging system for imaging, as further described herein. In examples, the sampled flakes are placed on a sampling plate (for example, perforated, slotted, or solid metal plate) which is mounted to a carriage on a rodless cylinder (for example, magnetically coupled rodless cylinder or pneumatic rodless actuator). In examples, the rodless cylinder is actuated to move the carriage and the sampling plate (with the sampled flakes thereon) in view of the camera for measurement of the thickness of the sampled flakes. (See, for example, the collection plate 4, the pneumatic cylinder 5, and the camera 6 of FIG. 2.) In examples, the sampling and imaging of flakes is initiated individually for each of the collection tubes one sample tube at time in sequence.

In examples, after measurement of the flake thickness, the carriage is returned to the home position and compressed air is used to clear the sampled flakes from the sampling plate. In examples, the spent flakes fall into a hopper and then are vacuum conveyed back into the flaker unit (101). (See, for example, the collection hopper 9 of FIG. 2.)

In examples, the camera uses 3D laser displacement to provide 3D scans of the flakes. (See, for example, the camera 6 of FIG. 2.) In examples, the camera can achieve sub-millimeter precision with a Z-axis resolution of 2.5 μm. In examples, the camera generates a set of 2D profile scans which are assembled into a 3D heightmap to measure flake thickness, as further described herein. In examples, to analyze the flake thickness, the images were preprocessed or “cleaned” before proceeding to analysis.

FIG. 2 is a schematic illustration of an example of an oilseed crush operation system (100) in accordance with the present disclosure. In examples, oilseeds (o) enter the top of the flaker unit (101) and are fed between opposing rollers (111) from a hopper (112) such that the oilseeds are crushed between the rollers (111) to form flakes (f), which, in examples, fall vertically from the rollers (111). In examples, samples of the flakes (f) are collected from a collection tube (1) that extends into the flaker unit (101) below the rollers (111). In examples, the sampled flakes are collected by creating a vacuum using an in-line pneumatic line vacuum (2). Although a single collection tube and vacuum are illustrated, one or more collection tubes and pneumatic vacuum lines may be used to collect flakes from different regions of the flaker unit (101) below the rollers (111). (See, for example, the sampling tubes 104, 105, and 106 of FIG. 1, and the sampling tubes 104, 105, 106, 108, and 109 of FIG. 1a.) In examples, samples are collected from each sampling location (for example, sequentially) through the use of individually controlled pneumatic gates to create an isolated vacuum for a respective collection tube.

In examples, the sampled flakes are deposited into a collection funnel (3) and deposited on a collection plate (4), as an example of a sampling plate or supporting surface. In examples, the collection plate (4) is moved via a pneumatic cylinder (5) under the 3D imaging camera (6), as an example of an imaging device. In examples, the images are digitally sent via a data connection (i) to a computer (7) to be processed for image quality and to determine and capture flake thickness data. The computer (7) may include a memory and a processor, with associated hardware and/or machine readable instructions (including firmware and/or software) embodied on a computer readable medium, for implementing and/or executing computer-readable, computer-executable instructions for data processing functions and/or functionality of the system and method. In examples, the flake thickness data is displayed on graphical user interface (GUI) communicated with the computer (7). In examples, the system (100) includes a programmable logic controller (PLC) (13), a power supply (14), and a network switch (15) for facilitating/establishing communication between the camera (6), the PLC (13), and the computer (7).

In examples, after the collection platform passes under the camera (6) for imaging, compressed air is delivered via an air-knife (8) which blows the imaged flakes into a collection hopper (9) for return to the production process via a return tube (10) using an in-line pneumatic line vacuum (11). In examples, a compressed air manifold (12) is used to manage the air pressure and flow. In examples, the supply line (A) supplies the air manifold (12) with compressed air. In examples, the manifold (12) supplies the flake extraction tube pneumatic vacuum with compressed air (B). In examples, the manifold (12) also supplies the compressed air to the air-knife (C), the pneumatic cylinder (D), and the flake return tube and vacuum (E).

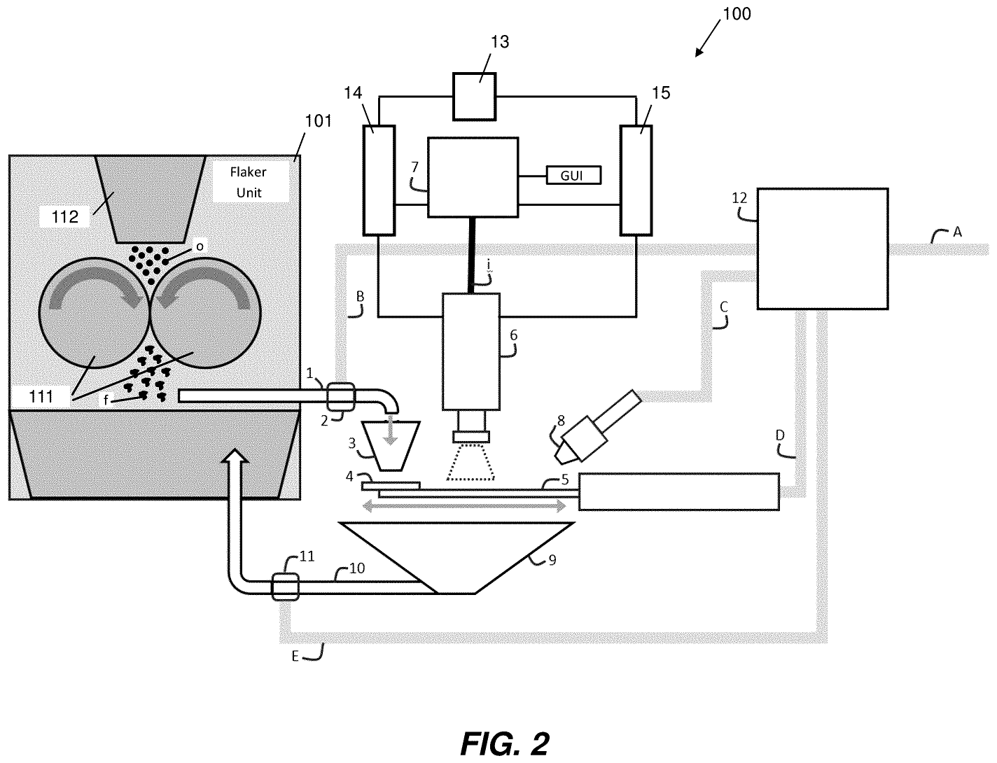

FIG. 3 is a flow chart of an example of an oilseed crush operation method (300) in accordance with the present disclosure. In examples, and as outlined and described herein, the oilseed crush operation method (300) includes collecting samples of the flakes, capturing images of the sampled flakes, processing the images of the sampled flakes to determine the flake thickness, and displaying the flake thickness data. In examples, after imaging, the measured flakes are returned to the production process.

More specifically, in examples, at 301, the method (300) includes initiating a Left, Center, Right ordered sample flake collection sequence. At 303, the method (300) includes a decision of collection of sample flakes from a Left, Center, or Right collection tube. At 305-1, the method (300) includes starting a Left collection tube pneumatic line vacuum to collect sample flakes from a Left collection tube, at 305-2, the method (300) includes starting a Center collection tube pneumatic line vacuum to collect sample flakes from a Center collection tube, and, at 305-3, the method (300) includes starting a Right collection tube pneumatic line vacuum to collect sample flakes from a Right collection tube. At 307, the method (300) includes depositing collected flakes in a collection funnel and dropping the collected flakes onto an imaging platform. At 309, the method (300) includes pneumatically moving the platform under an imaging camera. At 311, the method (300) includes capturing an image of the flakes with the imaging camera. At 313, the method (300) includes processing the flake image for a thickness measurement. At 315, the method (300) includes a decision of whether image data and quality is sufficient. If, at 315, the image data and quality is sufficient, at 317, the method (300) includes capturing flake thickness measurement data. At 319, the method (300) includes displaying flake thickness data. If, at 315, the image data and quality is not sufficient, at 321, the method (300) includes a decision of whether the image is a Left, Center, or Right image from the Left, Center, or Right collection tube. At 323, the method (300) includes repeating the current Left, Center, or Right collection cycle until image data and quality requirements are met. After capturing the image of the flakes at 311, at 312, the method (300) includes blowing measured flakes off the platform into a lower collection point with a pneumatic air knife. At 314, the method (300) includes returning the platform to a position under the flake collection funnel. At 316, the method (300) includes returning discarded flakes to the production process via the in-line pneumatic line vacuum.

FIG. 3a is a flow chart of an example of an oilseed crush operation method (300′) in accordance with the present disclosure. In examples, and as outlined and described herein, the oilseed crush operation method (300′) includes collecting samples of the flakes, capturing images of the sampled flakes, processing the images of the sampled flakes to determine the flake thickness, and displaying the flake thickness data. In examples, after imaging, the measured flakes are returned to the production process.

More specifically, in examples, at 301′, the method (300′) includes initiating a ordered flake collection sequence. At (300′), the method (300′) includes a decision of collection of sample flakes from collection tube 1, 2, 3, 4, or 5. At 305-1′, the method (300′) includes starting a Left Edge collection tube pneumatic line vacuum to collect sample flakes from a Left Edge collection tube, at 305-2′, the method (300′) includes starting a Left collection tube pneumatic line vacuum to collect sample flakes from a Left collection tube, at 305-3′, the method (300′) includes starting a Center collection tube pneumatic line vacuum to collect sample flakes from a Center collection tube, at 305-4′, the method (300′) includes starting a Right collection tube pneumatic line vacuum to collect sample flakes from a Right collection tube, and, at 305-5′, the method (300′) includes starting a Right Edge collection tube pneumatic line vacuum to collect sample flakes from a Right Edge collection tube. At 307′, the method (300′) includes depositing collected flakes in a collection funnel and dropping the collected flakes onto an imaging platform. At 309′, the method (300′) includes pneumatically moving the platform under an imaging camera. At 311′, the method (300′) includes capturing an image of the flakes with the imaging camera. At 313′, the method (300′) includes processing the flake image for a thickness measurement. At 315′, the method (300′) includes a decision of whether image data and quality is sufficient. If, at 315′, the image data and quality is sufficient, at 317′, the method (300′) includes capturing flake thickness measurement data. At 319′, the method (300′) includes displaying flake thickness data. If, at 315′, the image data and quality is not sufficient, at 321′, the method (300′) includes a decision of whether the image is a 1, 2, 3 ,4, or 5 image from collection tube 1, 2, 3, 4, or 5. At 323′, the method (300′) includes repeating the current collection cycle until image data and quality requirements are met. After capturing the image of the flakes at 311′, at 312′, the method (300′) includes blowing measured flakes off the platform into a lower collection point with a pneumatic air knife. At 314′, the method (300′) includes returning the platform to a position under the flake collection funnel. At 316′, the method (300′) includes returning discarded flakes to the production process via the in-line pneumatic line vacuum.

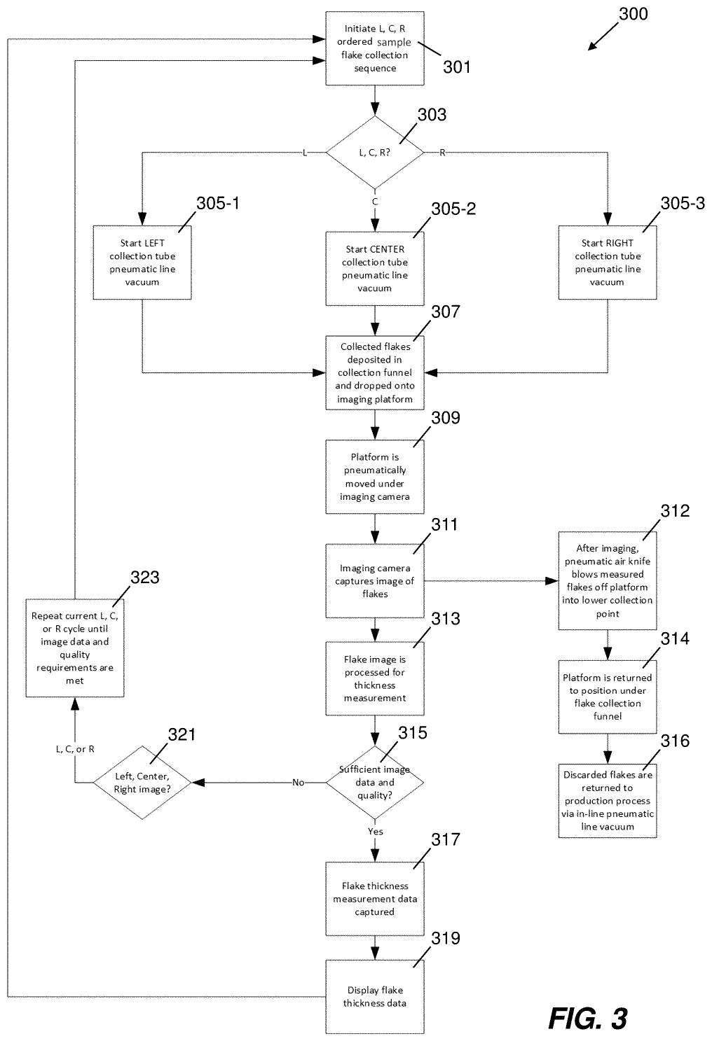

FIG. 4 is a schematic illustration of an example of an imaging system of an oilseed crush operation system in accordance with the present disclosure. In examples, the imaging camera (6) has a field of view (16) along a Z-axis and captures displacement profiles in the field of view (16). In examples, the sampled flakes (f), as deposited on the sampling plate (4), pass through the field of view (16), with the sampling plate (4) moving relative to the imaging camera (6) or the imaging camera (6) moving relative to the sampling plate (4). In examples, the imaging camera (6) scans the sampled flakes (f) to capture images of a surface of the flakes and generate 2D profiles of the flakes along the Z-axis, including a profile of flake dimensions relative to low and high point distances from a surface of the sampling plate (4). As such, in examples, the scans of the imaging camera (6) generate a top-down image of a sampled flake. In examples, the collection of 2D scans across an entire flake are assembled into a 3D heightmap.

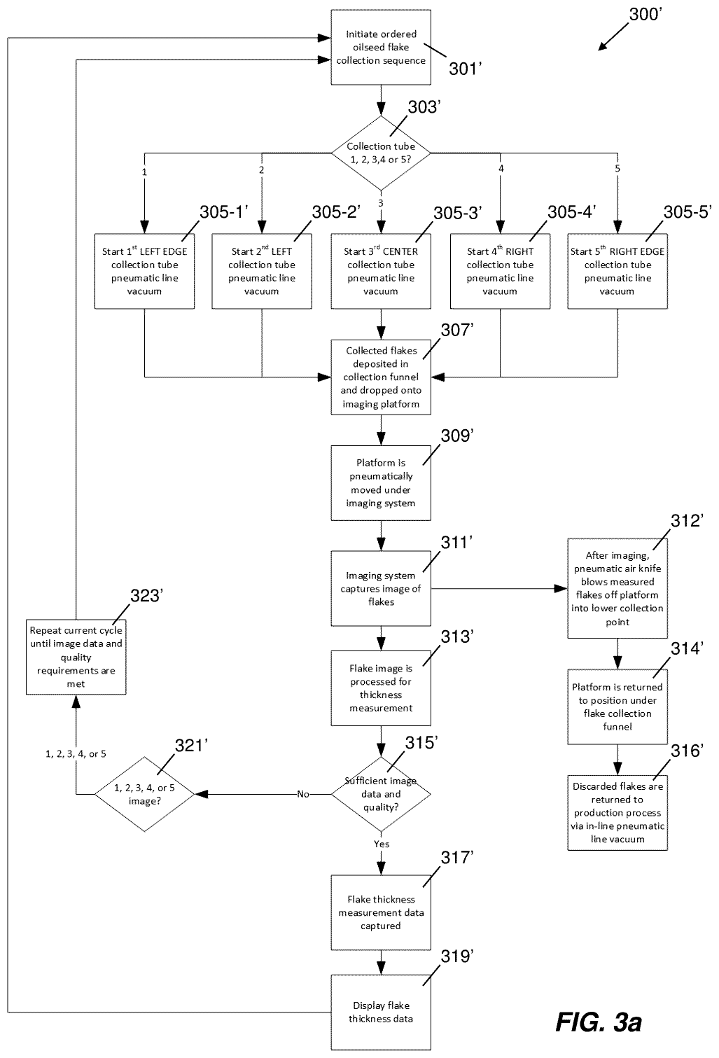

FIG. 5 is an example of a 3D heightmap of a flake surface of an oilseed crush operation system in accordance with the present disclosure. In examples, the 3D heightmap includes an assemblage of 2D scans of the surface of a sampled flake. In examples, flake thickness is measured by finding local minima regions (r) on the surface of the sampled flake encompassed by low points or low regions of the 3D heightmap, as further described herein. In examples, multiple minima regions (r) are selected from the 3D heightmap as representing areas where the flake (f) is directly touching the sampling plate, with flake thickness determined based on displacement of the minima regions (r) relative to a supporting surface (such as, for example, a surface of the sampling plate 4 of FIG. 2).

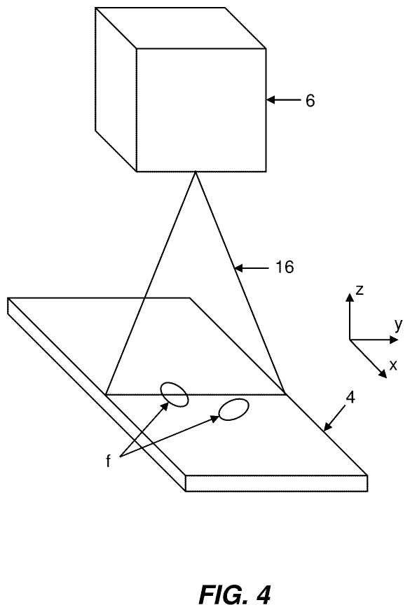

FIG. 6 is an example of data points representing a flake surface of an oilseed crush operation system in accordance with the present disclosure. In examples, with the 3D laser displacement of the imaging system, rich, high-precision data of the flake surface may be obtained. In the illustrated example of FIG. 6, the data provides approximately 60,000 3D coordinates of the flake surface. In examples, the Z-resolution (thickness) is 0.006 mm (0.000024 in.) and the X/Y resolution is 0.1 mm (0.003937 in.). With the data, various surface features, such as cracks, holes, peaks, and valleys of the flake surface, may be modeled.

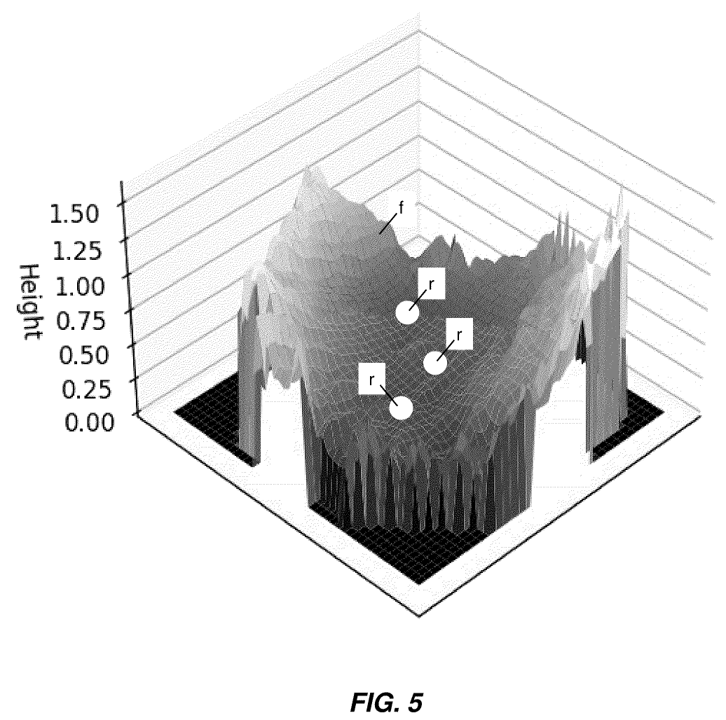

FIG. 7 is an example of an image of a flake surface of an oilseed crush operation system in accordance with the present disclosure. In examples, flake thickness is measured by finding local minima on the surface of the flake encompassed by low points or low regions of the 3D heightmap. In examples, multiple minima regions (r) are selected from the 3D heightmap as representing areas where the flake (f) is directly touching the sampling plate. As such, in examples, flake thickness is determined based on distances of the minima regions (r) from a supporting surface (such as, for example, a surface of the sampling plate 4 of FIG. 2).

In examples, to analyze the flake thickness, the images are preprocessed or “cleaned” before proceeding to analysis. In examples, preprocessing the images includes removing edges of the images of the flakes (for example, by utilizing convolutions with a specific kernel), and filtering the remaining portions of the images of the flakes (for example, by utilizing a Gaussian filter).

In examples, the local minima regions (r) of the flake surface are concave regions with near-zero gradient magnitudes. As such, in examples, areas with near-zero gradient magnitudes are identified, and the identified areas with near-zero gradient magnitudes are assessed for concavity or convexity. In examples, identifying the areas with near-zero gradient magnitudes includes thresholding or searching for minimum gradients of the surface profile of the flake. In examples, assessing for concavity or convexity includes determining second order gradients of the minima regions (r) (for example, by utilizing a Laplacian matrix). In examples, a second order gradient less than zero (i.e., negative) indicates concavity, and a second order gradient greater than zero (i.e., positive) indicates convexity. In examples, the local minima regions (r) are regions with near-zero gradient which are concave. As such, in examples, the local minima regions (r) of the flake surface are local concave minima regions.

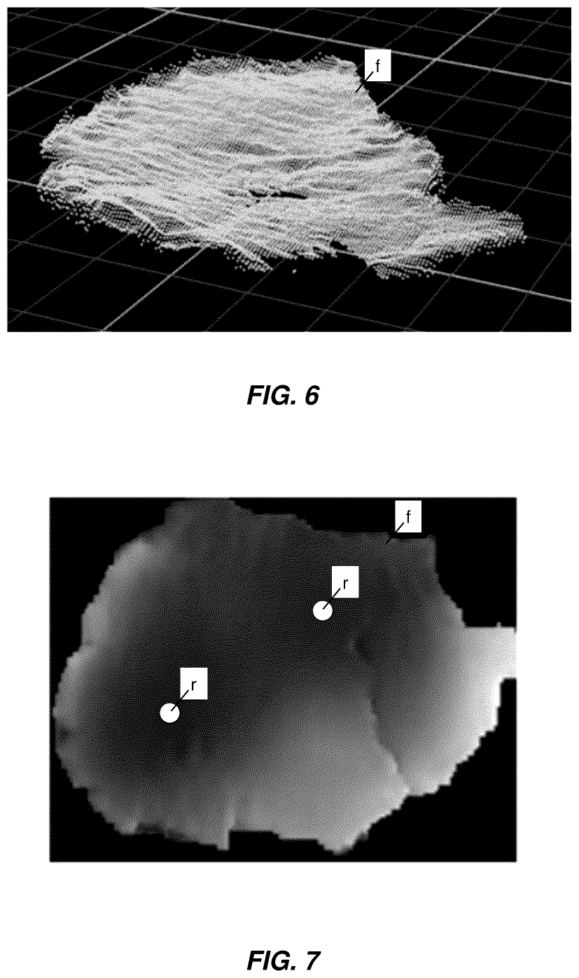

FIG. 8 is a schematic illustration of an example of a measurement of flake thickness of an oilseed crush operation system in accordance with the present disclosure. More specifically, FIG. 8 includes an example of a cross-sectional representation of a flake (f) on a sampling plate (4). In examples, flake thickness is measured by finding local minima regions (r) on the surface of the flake encompassed by low points or low regions of the 3D heightmap. In examples, the low regions include areas oriented substantially parallel to the sampling plate (4). In examples, multiple minima regions (r) are selected from the 3D heightmap as representing areas where the flake (f) is directly touching the sampling plate (4). In examples, displacement of the local minima regions (r) relative to the sampling plate (4) is used to calculate the flake thickness (t). In examples, an average displacement of the local minima regions (r) relative to the sampling plate (4) is used to determine the flake thickness (t).

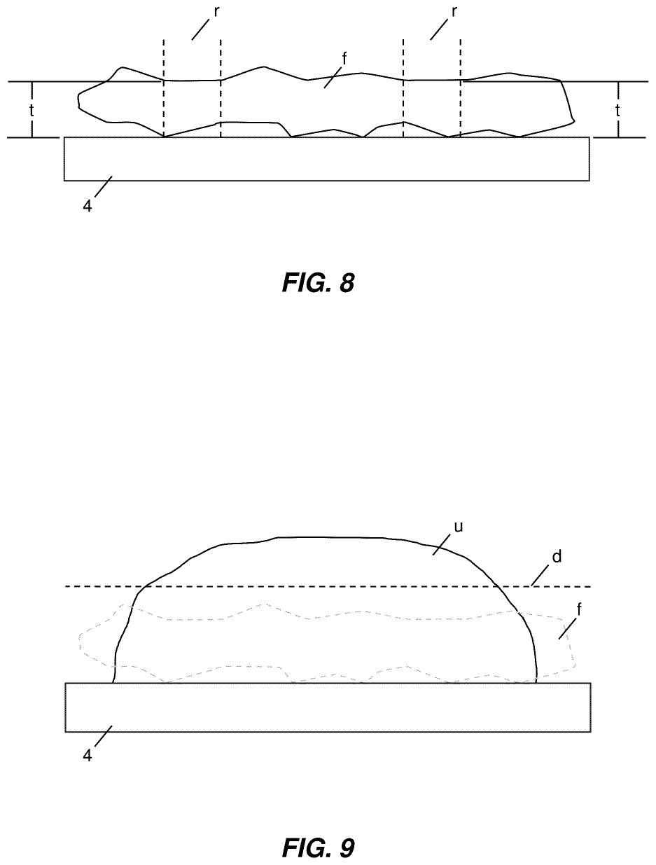

FIG. 9 is a schematic illustration of an example of a measurement of flake thickness of an oilseed crush operation system in accordance with the present disclosure. In examples, before the oilseeds are crushed to create flakes, the oilseeds are “cracked” by a cracking unit to loosen the hulls. In examples, unprocessed or incomplete processing of cracked oilseeds by the flaking unit may result in unflaked (for example, uncrushed or incompletely crushed) oilseeds, commonly referred to as “cracks” (i.e., “cracked” oilseeds that are unflaked). In examples, the oilseed crush operation system (100) may detect unflaked oilseeds. More specifically, in examples, the oilseed crush operation system (100) provides for measurement and/or detection of both flake thickness and unflaked oilseeds.

As illustrated in the example of FIG. 9, a cross-sectional representation of a flake (f) and an unflaked oilseed (u) are provided on the sampling plate (4). In examples, a displacement threshold (d) is used to determine if unflaked oilseeds (u) are present in the sampled material. Notably, unflaked oilseeds (u) are generally thicker than flaked oilseeds (f). Thus, in examples, if the sample is greater than the displacement threshold (d), the sample is considered an unflaked oilseed (u). In examples, if unflaked oilseeds (u) are present, a notification or alarm is initiated. As such, maintenance activities associated with the flaking unit, such as adjustment or replacement of the flake rollers (and/or cheek plates provided at the edges of the flake rollers) may be performed.

Although illustrated and described as being used to measure oilseed flakes, the system and method disclosed herein may also be used to measure other flaked goods or flaked food products including, for example, grain flakes such as oat flakes, wheat flakes, barley flakes, rye flakes, rice flakes, and corn flakes. Accordingly, a flake measurement system and method in accordance with the present disclosure includes collecting samples of flakes as disclosed herein, capturing images of the sampled flakes as disclosed herein, processing the images of the sampled flakes to determine the flake thickness as disclosed herein, and displaying data of the flake thickness as disclosed herein.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A flake measurement system of an oilseed crush operation, comprising:
a sampling system to collect an oilseed flake from the oilseed crush operation and place the oilseed flake on a supporting surface; and
an imaging system to determine a thickness of the oilseed flake, the imaging system including an imaging device to capture an image of a surface of the oilseed flake,
the imaging system to process the image to identify a local minima region of the surface of the oilseed flake,
the imaging system to determine the thickness of the oilseed flake based on displacement of the local minima region relative to the supporting surface.

2. The flake measurement system of claim 1, wherein:
the imaging device to generate 2D profile scans of the surface of the oilseed flake,
the imaging system to assemble the 2D profile scans into a 3D heightmap and identify the local minima region from the 3D heightmap.

3. The flake measurement system of claim 1, wherein:
the imaging system to process the image of the surface of the oilseed flake to identify a region of near-zero gradient, the local minima region comprising the region of near-zero gradient.

4. The flake measurement system of claim 3, wherein:
the imaging system to assess the region of near-zero gradient for concavity or convexity, the local minima region comprising the region of near-zero gradient having concavity.

5. The flake measurement system of claim 4, wherein:
the imaging system to determine a second order gradient of the region of near- zero gradient to assess the concavity or convexity.

6. The flake measurement system of claim 1, wherein:
the imaging system to pre-process the image of the surface of the oilseed flake to remove edges of the image.

7. The flake measurement system of claim 1, wherein:
the imaging system to pre-process the image of the surface of the oilseed flake with a Gaussian filter to filter the image.

8. The flake measurement system of claim 1, wherein:
the imaging system to identify multiple local minima regions of the surface of the oilseed flake and average the displacement of the local minima regions relative to the supporting surface to determine the thickness of the oilseed flake.

9. A flake measurement system of an oilseed crush operation, comprising:
an imaging system to determine a thickness of an oilseed flake processed by the oilseed crush operation,
the imaging system including an imaging device to capture images of a surface of the oilseed flake and generate 2D profile scans of the surface of the oilseed flake,
the imaging system to assemble the 2D profile scans into a 3D heightmap and determine a thickness of the oilseed flake from the 3D heightmap.

10. The flake measurement system of claim 9, wherein:
the imaging system to identify a local minima region of the surface of the oilseed flake from the 3D heightmap,
the imaging system to determine the thickness of the oilseed flake based on displacement of the local minima region relative to a surface supporting the oilseed flake.

11. A flake measurement method of an oilseed crush operation, comprising:
collecting an oilseed flake from the oilseed crush operation and placing the oilseed flake on a supporting surface;
capturing an image of a surface of the oilseed flake;
processing the image to identify a local minima region of the surface of the oilseed flake; and
determining a thickness of the oilseed flake based on displacement of the local minima region relative to the supporting surface.

12. The flake measurement method of claim 11, wherein:
capturing the image of the surface of the oilseed flake includes generating 2D profile scans of the surface of the oilseed flake, and
processing the image to identify the local minima region includes assembling the 2D profile scans into a 3D heightmap and identifying the local minima region from the 3D heightmap.

13. The flake measurement method of claim 11, wherein:
processing the image to identify the local minima region includes identifying a region of near-zero gradient, the local minima region comprising the region of near-zero gradient.

14. The flake measurement method of claim 13, wherein:
processing the image to identify the local minima region includes assessing the region of near-zero gradient for concavity or convexity, the local minima region comprising the region of near-zero gradient having concavity.

15. The flake measurement method of claim 14, wherein:
processing the image to identify the local minima region includes determining a second order gradient of the region of near-zero gradient to assess the concavity or convexity.

16. The flake measurement method of claim 11, further comprising:
pre-processing the image of the surface of the oilseed flake to remove edges of the image.

17. The flake measurement method of claim 11, further comprising:
pre-processing the image of the surface of the oilseed flake with a Gaussian filter to filter the image.

18. The flake measurement method of claim 11, wherein:
processing the image to identify the local minima region includes identifying multiple local minima regions of the surface of the oilseed flake, and
determining the thickness of the oilseed flake includes averaging the displacement of the local minima regions relative to the supporting surface.
